(19) United States
(12) Patent Application Publication
(10) Pub. No.: US 2009/0300741 A1
(43) Pub. Date: Dec. 3, 2009

(54) GRANTING SERVER/WORKSTATION ACCESS USING A TELEPHONE SYSTEM

(75) Inventors: Jason Greenwood, Madison, WI (US); Rob G. Jansen, Sauk Centre, MN (US); Erica C. Loppnow, Madison, WI (US); Taylor L. Schreck, Rochester, MN (US); Robert F. Stark, Rockford, MI (US)

Correspondence Address: CANTOR COLBURN LLP - IBM ROCHESTER DIVISION, 20 Church Street, 22nd Floor, Hartford, CT, 06103, US

(73) Assignee: International Business Machines Corporation, Armonk, NY (US)

(21) Appl. No.: 12/132,007

(22) Filed: Jun. 3, 2008

(51) Int. Cl. H04L 9/32

(52) U.S. Cl. 726/6

(57) ABSTRACT

A method of granting access to a computing system includes: receiving a connection request from a remote computing system; generating a first message indicating a session identification number and an access number; receiving the session identification number from a telephone system; performing a verification of the session identification number; and granting access to the computing system based on the verification of the session identification number.

### BACKGROUND

1. Field

This disclosure relates to methods, systems, and computer program products for granting access to a computing system using a telephonic communication.

2. Description of Background

The increased use of the Internet initiated the need to be able to securely access a remote computer over a network. For example, a service technician may need to access a remote server or workstation in order to perform maintenance on that server or workstation. In order to obtain access to the server or workstation, the service technician requests access to the server or workstation and access is granted before any maintenance can be performed. In some cases, a technical person may not be available at the site of the server or workstation to assist with granting access to the service technician.

Non-technical people are often apprehensive of allowing someone to access their server or workstation without being able to confirm that person's identity and that person's right to access the machine. This is especially the case when the server is a headless server and the non-technical user has no direct means for interfacing with the server. Therefore, it is important that the non-technical user be able to grant access to an outside party attempting to connect using a method that they can easily understand.

### SUMMARY

The shortcomings of the prior art are overcome and additional advantages are provided through the provision of a method of granting access to a computing system. The method includes: receiving a connection request from a remote computing system; generating a first message indicating a session identification number and an access number; receiving the session identification number from a telephone system; performing a verification of the session identification number; and granting access to the computing system based on the verification of the session identification number.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a user-friendly solution which allows a non-technical user to grant access to a third party attempting to connect to a computing system.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a computing system that includes a connection manager in accordance with an exemplary embodiment;

FIGS. 2A and 2B are block diagrams illustrating computing systems that include a connection manager in accordance with other exemplary embodiments;

FIG. 3 is a dataflow diagram illustrating the connection manager in accordance with an exemplary embodiment;

FIG. 4 is a flowchart illustrating a connection method that can be performed by the connection manager in accordance with an exemplary embodiment; and

FIG. 5 is a flowchart illustrating a connection method that can be performed by the connection manager in accordance with other exemplary embodiments.

The detailed description explains the preferred embodiments of the invention, together with advantages and features, by way of example with reference to the drawings.

### DETAILED DESCRIPTION

In an exemplary embodiment, methods, systems and computer program products are provided to assist a non-technical user with granting to a third party access to a computing system. The methods, systems and computer program products make use of a phone system, which is second hand to almost all non-technical users. In one example, the methods, systems and computer program products, generate a session identification (ID) and phone number for the party attempting to connect to the computing system. The third party can call the phone number and indicate the session ID to the non-technical user. The non-technical user then enters the session ID into the phone system and the methods, systems and computer program products grant access to the computing system upon verification of the session ID.

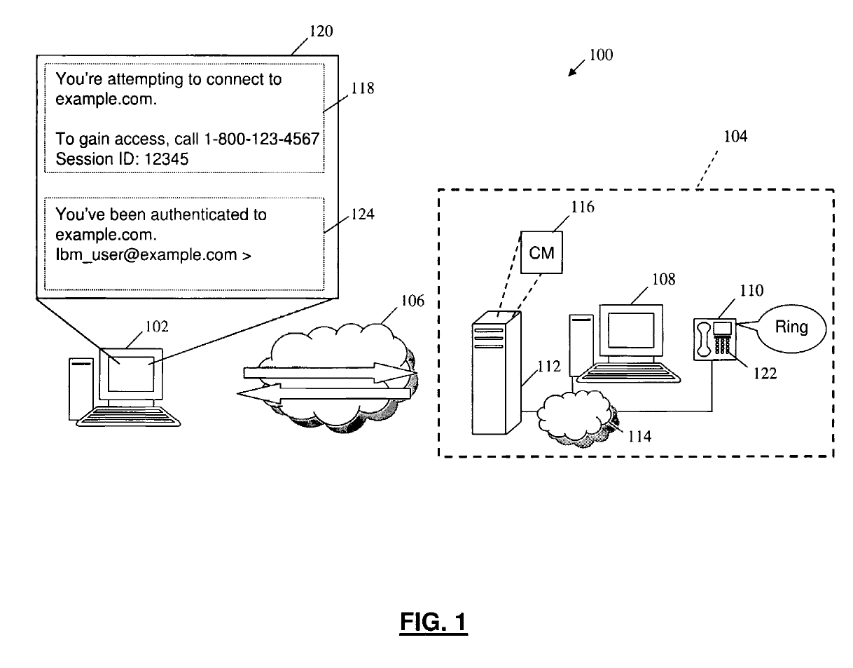

Turning now to the drawings in greater detail, it will be seen that in FIG. 1 a computing system 100 is shown to include a first computer 102 that is coupled to a customer network 104 via the Internet 106. The customer network 104 is shown to include one or more second computers 108, at least one telephone 110, and a server 112 that are communicatively coupled via an intranet 114.

As can be appreciated, the first computer 102 and the one or more second computers 108 may be any computer system including, but not limited to, a laptop, a desktop and a workstation. The first computer 102 and the one or more second computers 108 include a processor (not shown) and one or more data storage devices (not shown). The one or more data storage devices can be at least one of the random access memory, read only memory, a cash, a stack, or the like which may temporarily or permanently store electronic data. The first computer 102 and the one or more second computers 108 may be associated with one or more input devices (not shown) that may be used by a user to communicate with the corresponding first computer 102 and the one or more second computers 108. As can be appreciated, such input devices may include, but are not limited to, a mouse, a keyboard and a touchpad.

The server 112 similarly includes a processor (not shown) and one or more data storage devices (not shown). The one or more data storage devices can be at least one of the random access memory, read only memory, a cash, a stack, or the like which may temporarily or permanently store electronic data of the server 112. The processor of the server 112 is operable to execute one or more set of instructions contained in a software application. A connection manager application 116 of the present disclosure can be installed to the server 112 or run by the server 112 from a portable storage device such as, for example, a CD-ROM. The connection manager application 116, manages access requests from the Internet 106 (for example, access requests generated by the first computer 102) to the one or more second computers 108.

Generally speaking, the first computer 102 is used by, in one example, a service technician to remotely perform maintenance on one or more of the second computers 108 of the customer network 104. The first computer 102, hereinafter referred to as the requesting computer, initiates the connection by sending a connection request. Upon receiving a connection request, the connection manager application 116, generates a first reply message 118 indicating the location of the request, a phone number and a session ID. The first computer 102 displays this information to the service technician, for example, via a user interface 120. The service technician may then place a call to the phone number. When a customer user picks up the telephone 110, the service technician authenticates the call by providing the session ID. The customer user then enters the session ID and optionally a customer PIN into a keypad 122 of the telephone 110, which is then routed to the connection manager 116 of the server 112 for authentication. If the session ID and optionally the PIN are successfully authenticated, the connection manager 116 generates a second reply message 124 indicating that the service technician has been authenticated and that the connection request has been granted.

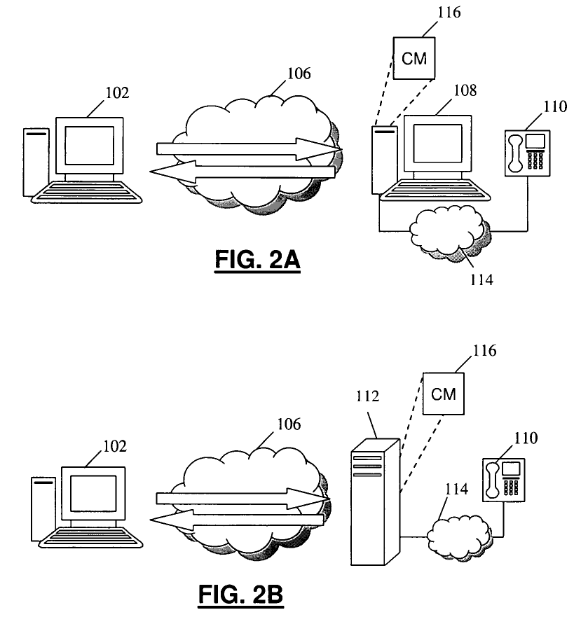

Turning now to FIGS. 2A and 2B, in other examples, the customer network does not include a server 112, rather, the connection manager 116 resides on one or more of the one or more second computers 108, as shown in FIG. 2A. In this case, the connection manager 116 manages connection requests for the computer on which the connection manager resides. In still other examples, the customer network includes only the server 112 and the connection manager 116 resides on the server 112. In this case, the connection manager 116 manages connection requests for the server 112 on which the connection manager 116 resides, as shown in FIG. 2B.

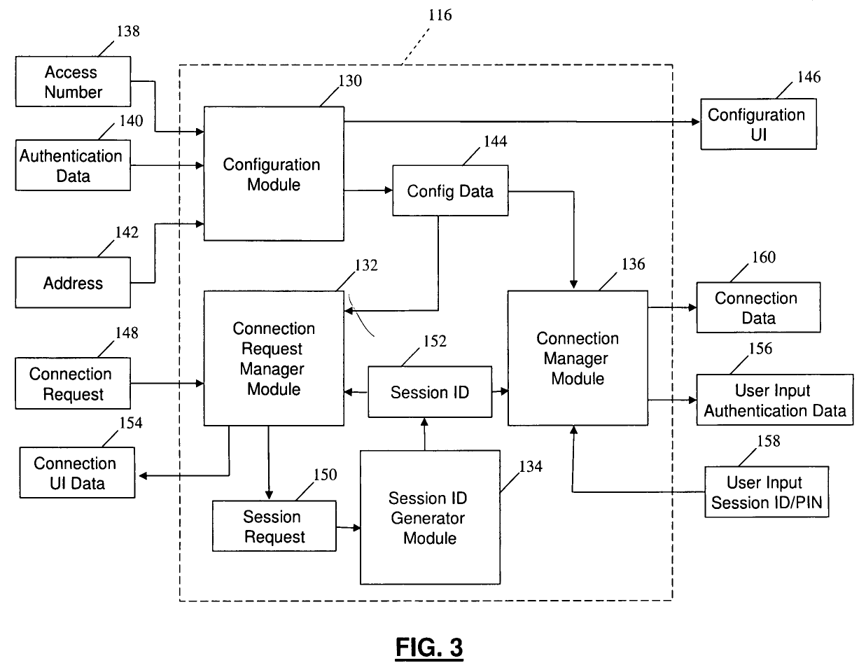

Turning now to FIG. 3, the connection manager 116 is shown in accordance with an exemplary embodiment. The connection manager 116 can include one or more modules. As can be appreciated, the modules can be implemented as software, hardware, firmware and/or other suitable components that provide the described functionality. As can be appreciated, the modules shown in FIG. 3 can be combined and/or further partitioned to similarly manage connection requests. In this example, the connection manager 116 includes a configuration module 130, a connection request manager module 132, a session identification (ID) generator module 134 and a connection manager module 136.

The configuration module 130 receives as input an access number 138, authentication data 140 and an address 142. The access number 138 can be, for example, a phone number corresponding to the telephone 110 (FIG. 1) of the customer network (FIG. 1). The authentication data 140 can include, but is not limited to include: a personal identification number (PIN) for one or more users of the customer network 104 (FIG. 1) that has permission to activate a session; voice recognition data relating to one or more of the users requesting connection; and/or connection information relating to the requesting computer. The address 142 indicates a memory location on the server or the computer for which access can be granted. Based on the inputs, the configuration module 130 generates configuration data 144. For example, the configuration data 144 includes one or more lookup tables for accessing the PINs, voice data, and/or connection data. The configuration data 144 can be used by the connection request manager module 132 and the connection manager module 136 for authentication purposes.

The connection request manager module 132 receives as input a connection request 148 and the configuration data 144. The connection request 148 can include an identifier of the requesting computer 102 (FIG. 1) and an identifier of the computer 108 (FIG. 1) to be connected to. Based on the connection request 148 and the configuration data 144, the connection request manager module 132 verifies the requesting computer 102 (FIG. 1) that is generating the request, determines a phone number that corresponds to the computer 108 (FIG. 1) to be connected to and generates a session request 150.

The connection request manager module 132 sends the session request 150 to the session ID generator module 134 to request a session ID 152. The session ID generator module 134 randomly generates the session ID 152 according to one or more random number generation algorithms known in the art.

Based on the session ID 152, the connection request manager module 132 generates connection user interface data 154 for the requesting computer 102 (FIG. 1) to display the user interface 120 (FIG. 1). The connection user interface data 120 includes at least the phone number and the session ID.

The connection manager module 136 receives as input the configuration data 144, the session ID 152, and user input (the session ID and optionally the PIN) 158. The user input is generated by the user entering information into the keypad 122 (FIG. 1) of the telephone 110 (FIG. 1). The connection manager module 136 compares the user input session ID 158 with the session ID 152 to authenticate the connection and in various embodiments, compares the user input PIN 158 with a PIN provided by the configuration data 144. When the session ID and optionally the PIN are verified, the connection manager module 136 generates connection data 160 to activate the session.

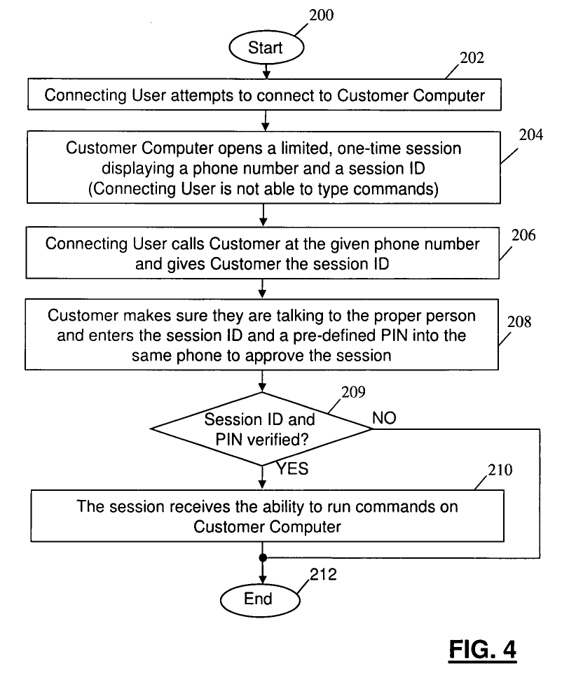

Turning now to FIG. 4, a connection method is shown that can be performed using the connection manager 116 of FIG. 3 in accordance with an exemplary embodiment. As can be appreciated in light of the disclosure, the order of operation within the method is not limited to the sequential execution as illustrated in FIG. 4, but may be performed in one or more varying orders as applicable in accordance with the present disclosure.

In one example, the method may begin at 200. At block 202, a connecting user attempts to connect to the computer 108 (FIG. 1). The connection manager 116 (FIG. 1) opens a limited one-time session displaying a phone number and a session ID at block 204. This session is limited to display only, the connecting user is unable to enter commands.

At block 206, the connecting user then calls the customer at the given phone number and provides to the customer the session ID. The customer can verify that they are talking to the proper person and then enters the session ID and optionally a predefined PIN into the same telephone to approve the session. If the session ID is correct and optionally the PIN is verified at 209, the session is given the ability to run commands on the computer 108 (FIG. 1) at 210. Thereafter, the method may end at 212. If, however, the session ID is incorrect or the PIN is incorrect at 209, the method may end at 212.

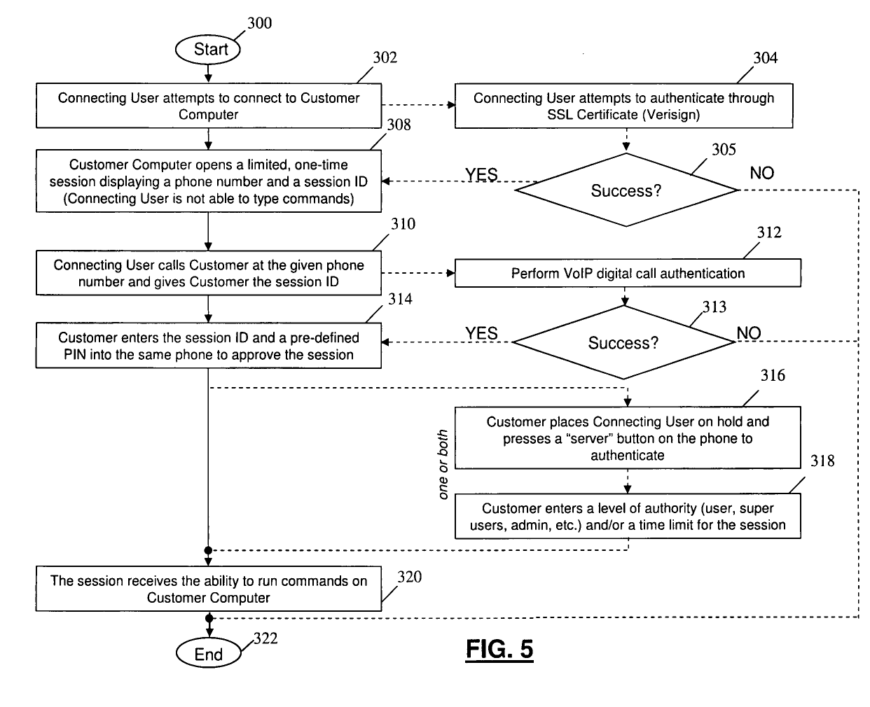

FIG. 5 is a flowchart illustrating a connection method that can be performed by the connection manager in accordance with other exemplary embodiments. As can be appreciated in light of the disclosure, the order of operation within the method is not limited to be sequential execution as illustrated in FIG. 4, but may be performed in one or more varying orders as applicable in accordance with the present disclosure.

In one example, the method may begin at 300. At block 302, a connecting user attempts to connect to the computer or server. In one example, at block 304, the connecting user attempts to authenticate the connection through a SSL certificate, for example using VeriSign. If the authentication of the connection fails at block 305, the method may and at block 322. If, however, the authentication of the connection is successful at 305, the customer computer 108 (FIG. 1) is able to open a limited, one-time session that displays a phone number and a session ID. In this example, the connecting user is not able to enter input or type commands in the session.

At block 310, the connecting user then calls the customer at the given phone number and provides to the customer the session ID. In this example, the voice of the connecting user can be verified using voice over IP digital call authentication at block 312. If the voice authentication fails at block 313, the method may end at 322. If however, the voice authentication is successful at 313, the customer enters the session ID and a predefined PIN into the same telephone 110 (FIG. 1) to approve the session at block 314.

Thereafter, at block 316, the customer can place the connecting user on hold and press a server button (not shown) on the telephone 110 (FIG. 1) or server 112 (FIG. 1) to authenticate and/or activate the connection. Alternatively or additionally, the customer can enter a level of authority (for example, user, superuser, admin, etc.) for the connecting user and/or time to limit the connection session at block 318. Thereafter, the session receives the ability to run commands on the computer 112 (FIG. 1) at block 320. Thereafter, the method may end at 322.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of granting access to a computing system, the method comprising:
receiving a connection request from a remote computing system;
generating a first message indicating a session identification number and an access number;
receiving the session identification number from a telephone system;
performing a verification of the session identification number; and
granting access to the computing system based on the verification of the session identification number.

2. The method of claim 1 further comprising:
receiving a personal identification number from the telephone system;
performing a verification of the personal identification number; and
wherein the granting access to the computing system is based on the verification of the personal identification number.

3. The method of claim 1 further comprising performing verification of the connection request.

4. The method of claim 1 further comprising:
a caller communicating the session identification number to a callee through a telephone system; and
performing voice recognition of the caller based on the communicating.

5. The method of claim 1 wherein the granting access to the computing system is based on at least one of a level of authority and a time limit.
